(19) United States
(12) Patent Application Publication
(10) Pub. No.: US 2014/0041019 A1
(43) Pub. Date: Feb. 6, 2014

(54) ELECTRONIC DEVICE AND METHOD FOR HIDING LOGIN INFORMATION

(71) Applicant: HO-LEUNG CHEUNG, Santa Clara, CA (US)

(72) Inventor: HO-LEUNG CHEUNG, Santa Clara, CA (US)

(21) Appl. No.: 13/666,977

(22) Filed: Nov. 2, 2012

(30) Foreign Application Priority Data
Aug. 3, 2012 (TW) 101127905

(51) Int. Cl. G06F 21/00

(52) U.S. Cl. 726/19; 726/16

(57) ABSTRACT

A method for hiding login information on an electronic device includes determining whether the electronic device generates a login interface for indicating a user to input account information and password; stopping sending display information of the electronic device to an external electronic device when the electronic device generates the login interface for indicating the user to input account information and password; receiving input account information and password; determining whether the user finishes inputting account information and password; sending the display information of the electronic device to the external electronic device when the user finishes inputting account information and password or logs into the electronic device according to the input account information and password. The electronic device is also described.

### BACKGROUND

1. Technical Field

The present disclosure relates to electronic devices and, particularly, to an electronic device and a method for hiding login information.

2. Description of Related Art

A user usually inputs personal information (account/password) to login a system. However, in public areas, if the user does not want the personal information or certain personal files to be seen by others, it can be troublesome.

Therefore, it is desirable to provide an electronic device and a method for hiding login information, which can overcome the above-mentioned shortcomings.

### BRIEF DESCRIPTION OF THE DRAWINGS

FIG. 1 is a functional block diagram of an electronic device, according to a first embodiment.

FIG. 2 is a flowchart showing a method for hiding login information by the electronic device of FIG. 1.

FIG. 3 is a functional block diagram of an electronic device, according to a second embodiment.

FIG. 4 is a flowchart showing a method for hiding login information by the electronic device of FIG. 3.

### DETAILED DESCRIPTION

Embodiments of the disclosure will be described with reference to the accompanying drawings.

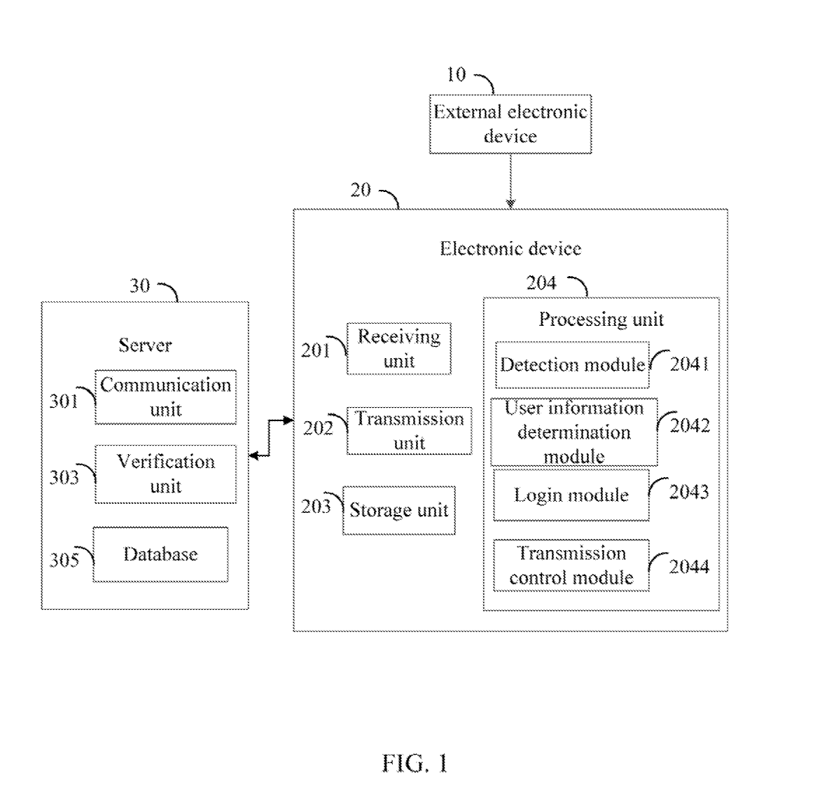

Referring to FIG. 1, a functional block diagram of an electronic device for hiding login information is provided. The electronic device 20 is connected with an external electronic device 10 and a server 30. The external electronic device 10 may be one or more display devices for transmitting display information of the electronic device 20. The external electronic device 10 may be a projector.

The electronic device 20 may be a computer or other electronic terminal with a network communication function. The server 30 is a networked server, which is connected with the electronic device 20 through network. The electronic device 20 includes a receiving unit 201, a transmission unit 202, a storage unit 203, and a processing unit 204. The receiving unit 201 receives data transmitted by the server 30. The transmission unit 202 sends data to the server 30 and the external electronic device 10. The storage unit 203 provides space for storing data.

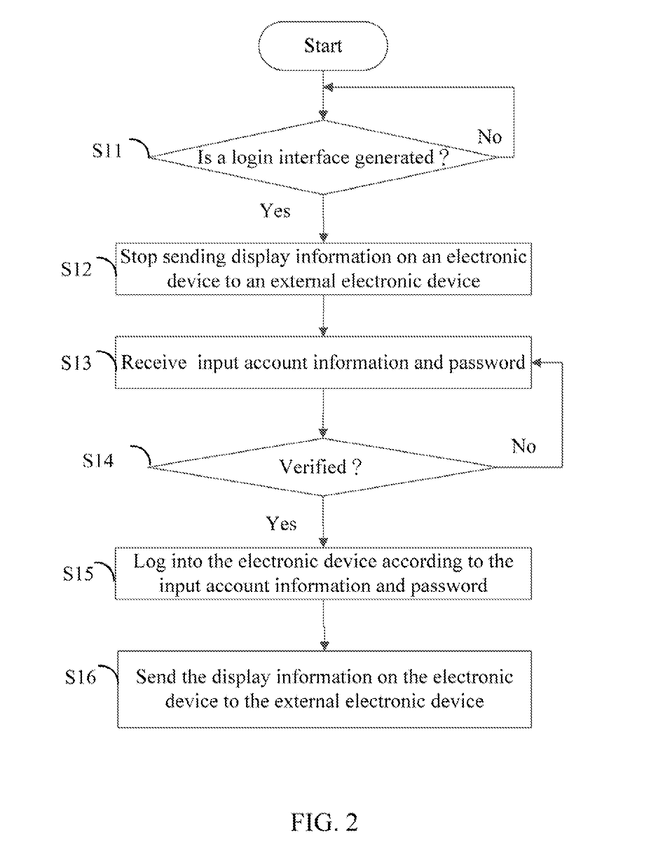

The processing unit 204 includes a detection module 2041, a user information determination module 2042, a login module 2043, and a transmission control module 2044. Functions of the modules will be described together with FIG. 2.

The server 30 includes a communication unit 301, a verification unit 303, and a database 305. The communication unit 301 receives data from the electronic device 20 and transmits user information from the database 305 to the electronic device 20. Functions of the server 30 will be described together with FIG. 2.

FIG. 2 is a flowchart showing a method for hiding login information by the electronic device of FIG. 1.

In step S11, the detection module 2041 determines whether the electronic device 20 generates a login interface for indicating the user to input account information and password. If yes, the procedure goes to the step S12, otherwise, the procedure repeats step S11.

In step S12, the transmission control module 2044 controls the transmission unit 202 to stop sending the display information of the electronic device 20 to the external electronic device 10.

In step S13, the receiving unit 201 receives the input account information and password.

In step S14, the user information determination module 2042 verifies whether the input account information and password match user information stored in the storage unit 203. If yes, the procedure goes to step S15, otherwise, the procedure returns to step S13.

In step S15, the login module 2043 logs into the electronic device 20 system according to the input account information and password.

In step S16, the transmission control module 2044 controls the transmission unit 202 to send the display information of the electronic device 20 to the external electronic device 10.

In other embodiments, steps S14 and S15 can be replaced by: the detection module 2041 determines whether the user finishes inputting the account information and password, if yes, the procedure goes to step S16, otherwise, the procedure jumps back to the step S13.

Through the method above, the electronic device 20 stops transmitting display information to the external electronic device 10 during inputting the account information and password, and sends the display information of the electronic device 20 to the external electronic device 10 after finishing inputting the account information and password or the user information corresponding to the input account information and password that is already stored in the storage unit 203.

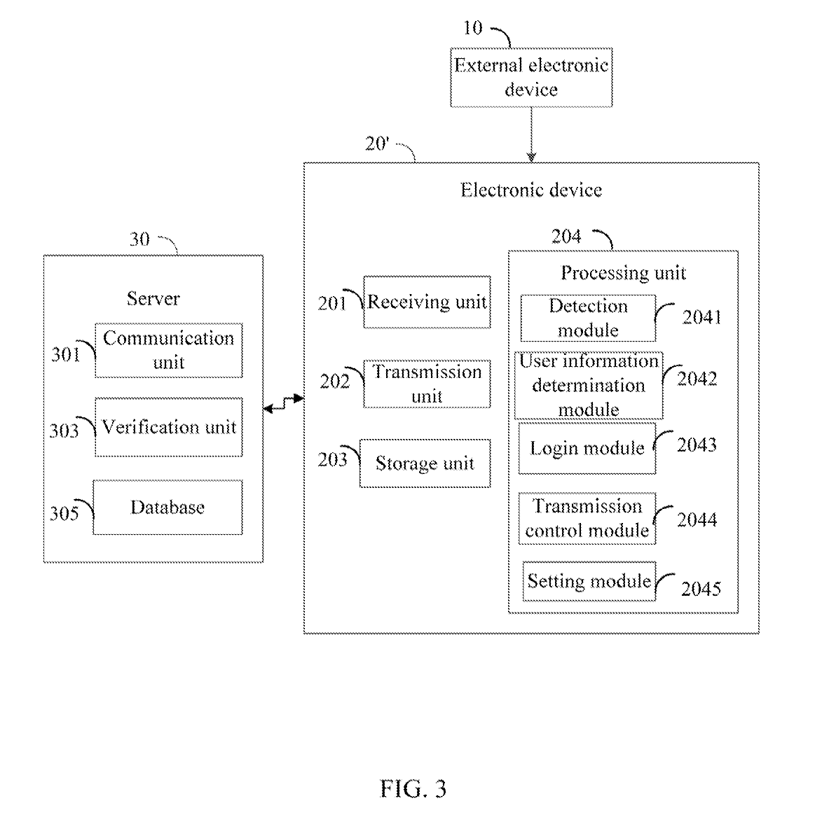

FIG. 3 is a functional block diagram of an electronic device, according to a second embodiment. Compared with FIG. 1, the electronic device 20′ further includes a setting module 2045 for setting different passwords with one same account information, wherein each of the passwords is associated with a number of files, when the user enters one password to login system, the electronic device 20′ displays the files associated with the password. For example, supposing the user account is ABC, the user can set the password 123 to associate with working files 1, set the password 234 to associate with private files 2.

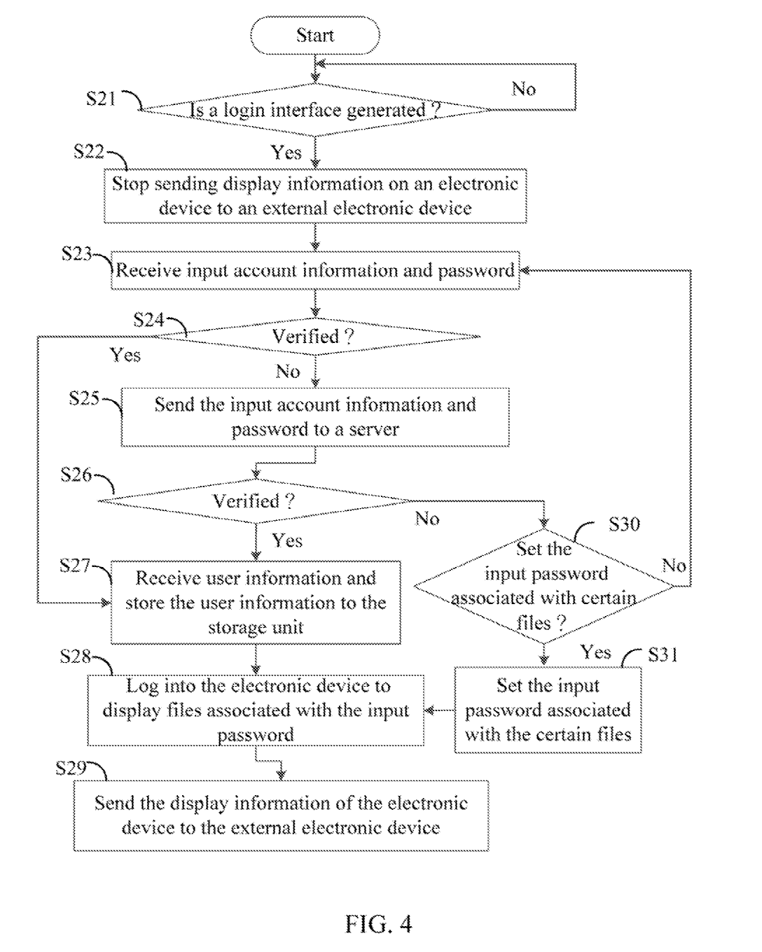

FIG. 4 is a flowchart showing a method for hiding login information by the electronic device of FIG. 3.

In step S21, the detection module 2041 determines whether the electronic device 20′ generates the login interface for the user to input account information and password. If yes, the procedure goes to the step S22, otherwise, the flow of the method repeats the step S21.

In step S22, the transmission control module 2044 controls the transmission unit 202 to stop sending the display information of the electronic device 20′ to the external electronic device 10.

In step S23, the receiving unit 201 receives the input account information and password.

In step S24, the user information determination module 2042 verifies whether the input account information and password match user information stored in the storage unit 203, if yes, the procedure goes to the step S27, otherwise, the procedure goes to the step S25.

In step S25, the transmission unit 202 sends the input account information and password to the server 30.

In step S26, the communication unit 301 receives the input account information and password, the verification unit 303 verifies whether the input account information and password match user information stored in the database 305, if yes, the procedure goes to the step S27, otherwise, the procedure goes to the step S30.

In step S27, the communication unit 301 of the server 30 sends the user information corresponding to the input account information and password to the electronic device 20′, the receiving unit 201 receives the user information and stores the user information to the storage unit 203.

In step S28, the login module 2043 logs into the electronic device 20 according to the input account information and password, especially, the login module 2043 logs in to the electronic device 20′ to display files associated with the input password when the input account information has been set with several different passwords.

In step S29, the transmission control module 2044 controls the transmission unit 202 to send the display information of the electronic device 20′ to the external electronic device 10.

In step S30, the setting module 2045 determines whether the user wants to set the input password associated with certain files, for example, the setting module 2045 determines whether a setting button (not shown) is pressed, if yes, the procedure goes to the step S31, otherwise, the procedure goes to the step S23.

In step S31, the setting module 2045 sets the input password associated with the certain files.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An electronic device for hiding login information on an external electronic device, the electronic device, comprising:
a receiving unit, to receive input account information and password;
a transmission unit;
a storage unit; and
a processing unit comprising:
a detection module, to determine whether the electronic device generates a login interface for indicating a user to input account information and password and whether the user finishes inputting account information and password;
a transmission control module, to control the transmission unit to stop sending display information of the electronic device to the external electronic device when the electronic device generates the login interface for indicating the user to input account information and password, and send the display information of the electronic device to the external electronic device when the user finishes inputting account information and password.

2. The electronic device according to claim 1, further comprising a user information determination module to verify whether the input account information and password match user information stored in the storage unit; and a login module to log into the electronic device according to the input account information and password when the input account information and password is verified.

3. The electronic device according to claim 1, wherein the external electronic device is a display device for displaying information of the electronic device.

4. An electronic device for hiding login information on an external electronic device, the electronic device, comprising:
a receiving unit, to receive input account information and password;
a transmission unit;
a storage unit; and
a processing unit, further comprising:
a detection module, to determine whether the electronic device generates a login interface for indicating a user to input account information and password and whether the user finishes inputting account information and password;
a transmission control module, to control the transmission unit to stop sending display information of the electronic device to the external electronic device when the electronic device generates the login interface for indicating the user to input account information and password, and send the display information of the electronic device to the external electronic device when the electronic device logs in system according to the account information and password.

5. The electronic device according to claim 4, further comprising a user information determination module to verify whether the input account information and password match user information stored in the storage unit; and a login module to log into the electronic device according to the input account information and password when the input account information and password is verified by the user information determination module.

6. The electronic device according to claim 4, further comprising a setting module for setting different passwords with one same account information, each password is associated with a number of files, wherein the login module logs into the electronic device to display files associated with the input password when the input account information has been set with several different passwords.

7. The electronic device according to claim 4, wherein the transmission unit sends the input account information and password to a server when the input account information and password is not verified by the user information determination module, the receiving unit receives user information corresponding to the account information and password when the input account information and password is verified by the server and stores the user information to the storage unit.

8. The electronic device according to claim 4, wherein the external electronic device is a display device for displaying information of the electronic device.

9. A method for hiding login information on an electronic device, comprising:
determining whether the electronic device generates a login interface for indicating a user to input account information and password;
stopping sending display information of the electronic device to an external electronic device when the electronic device generates the login interface for indicating the user to input account information and password;
receiving account information and password;
determining whether the user finishes inputting account information and password;
sending the display information of the electronic device to the external electronic device when finishing inputting account information and password or logging into the electronic device according to the input account information and password.

10. The method according to claim 9, further comprising verifying whether the input account information and password match user information stored in a storage unit; and logging into the electronic device according to the input account information and password when the input account information and password is verified by the electronic device.

11. The method according to claim 9, further comprising setting different passwords with one same account information, wherein each password is associated with a number of files, and the method of logging into the electronic device according to the account information and password when the input account information and password is verified further comprises logging into the electronic device to display files associated with the input password when the input account information has been set with several different passwords.

12. The method according to claim 9, further comprising sending the account information and password to a server when the input account information and password is not verified, receiving the user information corresponding to the account information and password when the input account information and password is verified by the server, and storing the user information to the storage unit.
